(19) United States
(12) Patent Application Publication
(10) Pub. No.: US 2015/0072714 A1
(43) Pub. Date: Mar. 12, 2015

(54) GEOLOCATION TOOL

(71) Applicants: Robert William Froehlich, McKinney, TX (US); Martin Winau, Berlin (DE)

(72) Inventors: Robert William Froehlich, McKinney, TX (US); Martin Winau, Berlin (DE)

(73) Assignee: TEKTRONIX, INC., Plano, TX (US)

(21) Appl. No.: 14/022,898

(22) Filed: Sep. 10, 2013

(51) Int. Cl. H04W 4/02

(52) U.S. Cl. CPC H04W 4/023
USPC 455/457

(57) ABSTRACT

A method for providing accurate geolocation information is described in which geolocation information is received from a plurality of position information sources. A confidence indicator value is associated with each of the plurality of position information sources. Geolocation information received from two or more of the plurality of position information sources is combined based on the confidence value associated with each of the plurality of position information sources. A geolocation accuracy indicator (e.g., a graphical indicator) is provided to a user.

### FIELD OF THE INVENTION

Embodiments of the present invention relate to estimating the location of a wireless mobile device that is in communication with a wireless communication network, and particularly to a geolocation tool.

### BACKGROUND OF THE INVENTION

The increased terminal mobility offered by cellular telephone networks as well as mobile and WiFi radio data networks has brought about an increased demand for location-based services and applications. Location based services include, for example, fleet management, vehicle tracking, tracking for theft recovery, telemetry, emergency services, location identification, navigation, location based information services and location based advertising. A wide variety of technologies for locating mobile devices have been developed.

Typical mobile device location technologies may be classified into external methods and network based methods. One example of an external method is the Global Positioning System (“GPS”). Network based methods may be further categorized depending on whether it is the network or the mobile device that performs necessary signal measurements. These signal measurements may involve the reception time of signals communicated between a base station and a mobile device, the angle of arriving signals or round trip delay measurements of signals communicated between a serving base station and a mobile device, or combinations thereof.

However, for many current and future location based applications, accuracy of the calculated position information should be improved.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with a purpose of the illustrated embodiments, in one aspect, a method for providing accurate geolocation information is described in which geolocation information is received from a plurality of position information sources. A confidence indicator value is associated with each of the plurality of position information sources. Geolocation information received from two or more of the plurality of position information sources is combined based on the confidence value associated with each of the plurality of position information sources. A geolocation accuracy indicator (e.g., a graphical indication of certainty) is provided to a user.

In another aspect, a computer program product for providing accurate geolocation information is provided. The computer program product comprises one or more computer-readable storage devices and a plurality of program instructions stored on at least one of the one or more computer-readable storage devices. The plurality of program instructions comprises program instructions to receive geolocation information from a plurality of position information sources. The plurality of program instructions further comprises program instructions to associate a confidence indicator with each of the plurality of position information sources. The plurality of program instructions further comprises program instructions to combine the geolocation information received from two or more of the plurality of position information sources based on the confidence indicator associated with each of the plurality of position information sources. The plurality of program instructions further comprises program instructions to provide a geolocation accuracy indicator.

### BRIEF DESCRIPTION OF THE DRAWINGS

The accompanying appendices and/or drawings illustrate various, non-limiting, examples, inventive aspects in accordance with the present disclosure:

FIG. 1 illustrates an example communication network in accordance with an illustrated embodiment;

FIG. 2 is a schematic diagram of a mobile device used in the system of FIG. 1 in accordance with an alternative embodiment;

FIG. 3 is a flowchart of operational steps of a geolocation application used in the system of FIG. 1 and in the mobile device of FIG. 2 in accordance with illustrative embodiments of the present invention; and

FIG. 4 illustrates internal and external components of a geolocation server computer of FIG. 1 in accordance with an illustrative embodiment of the present invention.

### DETAILED DESCRIPTION OF CERTAIN EMBODIMENTS

The present invention is now described more fully with reference to the accompanying drawings, in which illustrated embodiments of the present invention is shown wherein like reference numerals identify like elements. The present invention is not limited in any way to the illustrated embodiments as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims.

The term “geolocation”, as used herein, refers to a geographic location of a mobile device as well as geographic location of a communication event observed by mobile communication equipment. The term “communication event”, as used herein, refers to any incoming or outgoing communication to or from a mobile device. Communication events include mobile station attachment, detachment, handover procedures, telephone calls, both sent and received, SMS messages both sent and received, e-mail correspondences both sent and received, and wireless application protocol sessions, among other data based transactions. Each communication event has at least two parties, the user of the mobile device and at least one correspondent element. The terms “mobile device” and “mobile station” may be used interchangeably herein.

A communication network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

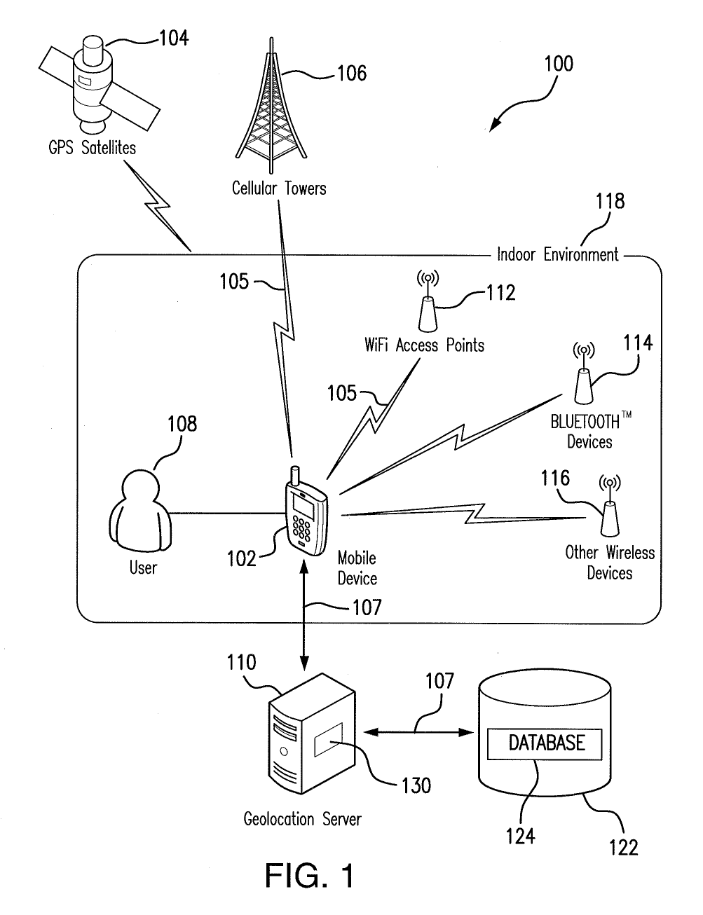

FIG. 1 is a schematic block diagram of an example communication network 100 illustratively comprising nodes/devices 102-106 and 110-122 (e.g., mobile devices, servers, routers, wireless stations, satellites, and the like) interconnected by various methods of communication. For instance, the links 105 may comprise a wireless communication medium, where certain nodes are in communication with other nodes, e.g., based on distance, signal strength, current operational status, location, etc. The links 107 may be wired links. Moreover, each of the devices can communicate data packets (or frames) with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

FIG. 1 illustrates an exemplary network 100 in which an embodiment of the present invention may be implemented. The network 100 includes a mobile device 102 and a geolocation server 110. A user 108 may use the mobile device 102 to determine his or her geolocation as well as geolocation information corresponding to a plurality of communication events, both sent and received, by the mobile device 102. The mobile device 102 may enable this by monitoring, for example, identifiable radio frequency (RF) signals received over a period of time and transmitting the wireless signal data, for example, to the carrier's geolocation server 110. The data collected by the mobile device 102 may include, for each signal detected, the signal source's identification information, such as a IMSI, MSISDN, MAC or EUI identifier or the signal's frequency; the signal's average signal strength; the standard deviation of its signal strength; and its yield, which is a measure of how often the signal is detected over a given time period. When monitoring, the mobile device 102 may collect a plurality of samples, or “polls”, of the detectable signals. In addition to collecting signal-related information, the mobile device 102 may collect a plurality of control parameters. For example, when the user 108 initiates or receives a call or text message, radio communication takes place between the handset and a base station. As well as transmitting an encoding of the message passing between caller and call recipient, the mobile device 102 and the base station transmit a large amount of control information between themselves for the purposes of reliably and efficiently supporting the call and passing it between base stations as the user 108 moves about. This control information may contain information on the signal strength of neighboring base stations, timing advance information to instruct mobile devices further from the base station to transmit earlier in order to match its time slot, transmission error rates and much more. Collectively these parameters are referred to herein as the “control parameters”. From this information, the geolocation server 110 determines accurate information related to the geolocation of the mobile device 102 and the geolocation of the corresponding communication events, as described below. The geolocation server 110 may send the geolocation information of interest back to the mobile device 102. The mobile device 102 may display the received geolocation information (e.g. accuracy indicator described below) to the user 108 utilizing, for example, a graphical user interface (GUI) (not shown in FIG. 1). It is contemplated that the geolocation server 110 may have the interaction capabilities with one or more data centers and/or servers belonging to various mobile application providers (not shown in FIG. 1) in order to enable the exchange of geolocation information.

As depicted in FIG. 1, wireless signals can originate from WiFi access points 112, BLUETOOTH™ devices 114, and/or other RF wireless stations 116, which may include RFID readers, ZIGBEE™ devices, or any such device which emits a wireless signal, if the mobile device 102 is equipped with an appropriate receiver. Collectively, these signal sources will be referred to as “position information sources”. At least some of the position information sources 112-116 may be present in the indoor environment 118. The mobile device 102 also may receive signals from cell towers 106 and/or GPS satellites 104. Cellular towers 106 may provide location information using triangulation or other methods described below. However, it is challenging to precisely determine mobile device's 102 location based on cell phone triangulation. Also, while GPS satellites 104 send signals that may be received by the mobile device 102 while it is outside of the indoor environment 118, GPS signals do not usually effectively reach such devices inside most indoor environments. Therefore, according to an embodiment of the present invention, rather than relying solely on cellular and/or GPS position information sources, a geolocation application 130, running, for example, on the geolocation server 110, as described herein, may utilize and combine the geolocation information received from the plurality of position information sources 104-106 and 112-116 in order to provide more accurate and reliable geolocation information.

It is noted that the mobile device 102 is depicted in FIG. 1 as a mobile wireless device such as a cell phone or smart phone. However, it may be any portable device, such as a laptop, notebook, tablet computer, palm-sized computer, or any electronic device with capability to receive communication (i.e. wireless) signals.

Geolocation application 130 may comprise program instructions stored on one or more computer-readable storage devices, which may include internal storage on the geolocation server 110. Geolocation application 130 may be, for example, a computer program or program component for determining accurate geolocation information and for providing a geolocation accuracy indicator to the user 108. Data gathered, generated, and maintained for use by the geolocation application 130 may be kept in the internal storage of the geolocation server 110 or in one or more databases 124 of a storage unit 122.

According to an illustrative embodiment shown in FIG. 1, the geolocation application 130 may be implemented in a client-server system environment. In such a case, the user 108 interacts with the user interface, such as GUI, on the mobile device 102 (a client device), and the GUI on the mobile device 102 communicates with the geolocation application 130 running on one or more geolocation servers 110 over a network link 107. The link 107 may be either a wireless or a wired link. Using a “distributed” technique, at least some of the processing associated with geolocation information may be shifted to another processing element, such as the geolocation server 110. For example, one or more mobile device(s) 102 may continuously send monitoring data to the geolocation server 110. When the user 108 requests a specific geolocation information, which may include a geolocation accuracy indicator, the geolocation application 130 running on the geolocation server 110 may perform some or all of the geolocation information-related tasks described below and may return processing results, such as combined geolocation information and/or the geolocation accuracy indicator to the mobile device 102. The mobile device 102 may display the received geolocation information to the user 108 utilizing, for example, the GUI (not shown in FIG. 1).

In one embodiment of the present invention, the mobile device 102 may comprise a conventional mobile user equipment (UE) device. Although not specifically shown, in this embodiment, the network 100 may include a radio access network (RAN) and a core network (CN). The RAN may include a number of base stations, each base station providing wireless access to a respective service coverage region. In alternative embodiments, the RAN may include other types of access points that include relays, femto-cells and pico-cells.

For purposes of the present patent application, the RAN may be implemented in any combination of known or heretofore unknown radio access technology and network protocols. For instance, the RAN may comprise a combination of UMTS Terrestrial Radio Access Network (UTRAN), Wireless Local Area Network (WLAN), Digital Enhanced Cordless Technology (DECT), GSM EDGE Radio Access Network (GERAN), Worldwide Interoperability for Microwave Access (WiMAX) network, Device to Device (D-D), etc. The RAN can also be an aggregation of channels from multiple bands in the radio access technology LTE-A (Long Term Evolution-Advanced). LTE-A is a set of enhancements to the Universal Mobile Telecommunication System (UMTS) that includes an all-IP networking architecture and the ability of each base station to connect to multiple core networks.

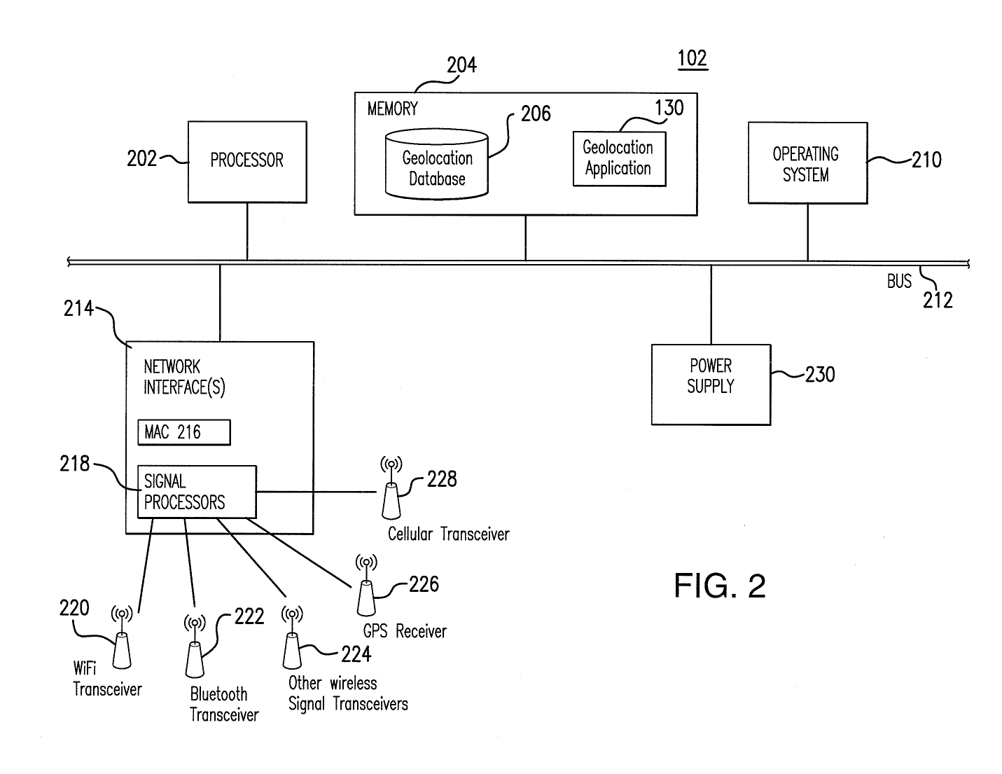

FIG. 2 is a schematic block diagram of an example mobile device 102 that may be used with one or more embodiments described herein. The mobile device 102 may comprise one or more network interfaces 214, at least one processor 202, and a memory 204 interconnected by a system bus 212.

FIG. 2 illustrates an alternative embodiment of the present invention. Unlike the embodiment illustrated in FIG. 1, this embodiment contemplates that the mobile device 102, rather than the geolocation server 110, processes the geolocation information. To do this, the memory 204 of the mobile device 102 contains both a geolocation database 206 and the geolocation application 130. The memory 204 comprises a plurality of storage locations that are addressable by the processor 202, MAC 216, the network interfaces 214 and by the software programs associated with the embodiments described herein, such as the geolocation application 130. Geolocation application 130 may comprise program instructions stored on one or more computer-readable storage devices, which may include the memory 204 of the mobile device 102. Geolocation application 130 may be, for example, a computer program or program component for determining accurate geolocation information and for providing a geolocation accuracy indicator to the user 108. In this embodiment, the geolocation application 130 may include the GUI. The geolocation database 206 may store various geolocation information including described herein geolocation positioning data collected by the mobile device 102 from the plurality of position information sources 104-106 and 112-116 (shown in FIG. 1). The geolocation database 206 may also store processing results, such as confidence indicators associated with each of the plurality of position information sources 104-106 and 112-116, as well as geolocation accuracy indicators described below. According to an embodiment of the present invention, the mobile device 102 may store only a subset of the full geolocation information in its memory 204, based on predetermined configuration options, user input, or through other means. The geolocation database 206 could be received and/or updated through the mobile device 102 provider's network, through a WiFi connection, though a physical connection to a computer, or through other means. According to an embodiment of the present invention, when the geolocation application 130 is run, it preferably references the geolocation database 206 stored within the memory 204 of the mobile device 102 rather than interacting with a remote geolocation information system.

The network interface(s) 214 may contain the mechanical, electrical, and signaling circuitry for controlling operation of the mobile device 102 and may include a media access controller (MAC) 216, which can communicate data to/from network 100 using a variety of different communication protocols. According to various embodiments of the present invention, the mobile device 102 may comprise several receivers and transceivers, including, but not limited to, WiFi transceiver 220, BLUETOOTH™ transceiver 222, other wireless RF signal receivers or transceivers 224, GPS receiver 226, and cellular transceiver 228. These receivers and transceivers receive external wireless signals from the plurality of position information sources 104-106 and 112-116 depicted in FIG. 1. The network interface(s) 214 of the mobile device 102 may also include signal processors 218, such as analog to digital converters, digital signal processors, or any such processor required to process and characterize the wireless signal received.

The one or more processor(s) 202 may comprise hardware elements or hardware logic adapted to execute the software programs and manipulate the data structures. The one or more processor(s) may receive information about the detected wireless signals through the signal processors 218 and may execute the geolocation application 130 stored in the memory 204 to determine accurate geolocation information.

An operating system 210, portions of which are typically resident in the memory 204 and executed by the processor 202 and/or network interfaces 214 (i.e., via MAC 216), functionally organizes the device by, inter alia, invoking operations in support of software processes and/or services executing on the mobile device 102.

A power supply 230 may be any of numerous types of stand-alone electrical power sources. For example, the power supply 230 may include one or more batteries and appropriate signal conditioning circuitry or it may be a thermoelectric power source, or it may be a vibration-powered generator that converts mechanical power to electrical power. In a particular example, the power source 230 is implemented as a battery.

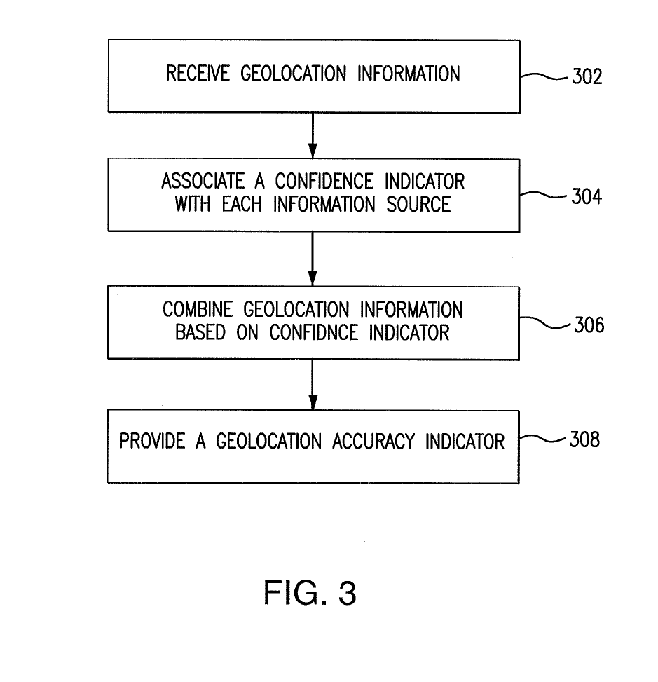

In summary, when the user 108 runs the geolocation application 130, the mobile device 102 collects geolocation data over a period of time from the wireless signals it detects within range using the transceivers 220-228 to obtain for each signal detected the source signal's identification information, such as a MAC or EUI identifier or the signal's frequency; its average signal strength; its standard deviation of the signal strength; and its yield as defined above. The geolocation application 130 then processes the received geolocation information according to the methodology described below in relation to FIG. 3.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Illustratively, the techniques described herein may be performed by hardware, software, and/or firmware, such as in accordance with the geolocation application 130, which may contain computer executable instructions executed by the one or more processor(s) 202 (and/or MAC 212) to perform functions relating to the techniques described herein.

FIG. 3 is a flowchart of operational steps of a geolocation application used in the system of FIG. 1 in accordance with an illustrative embodiment of the present invention. As shown in FIG. 3, at step 302, the geolocation application 130 may collect geolocation information, such as position estimates, from the plurality of position information sources 104-106 and 112-116. Before describing the operational steps in detail, a brief overview of different geolocation technologies is provided below.

Currently in the art, there are a number of different methodologies to geolocate a mobile device. Typical mobile device geolocation technologies may be classified into mobile device based methods and network based methods. Some non-limiting examples of the mobile devise based geolocation technologies include WiFi fingerprinting services, satellite based position information and network ‘triangulation’ based location systems.

In an embodiment of the present invention, the geolocation application 130 may receive geolocation (positioning) information from a WiFi positioning system (WPS). WPS can provide position in certain situations (such as indoors) by taking advantage of the rapid growth of the WiFi Access points (WAPs) 112 in urban areas. A provider of this type of service may maintain a public database and can determine the position for a device based on the specific access points accessible from the device in each specific location. The localization technique used for positioning with the WAPs 112 is based on measuring the intensity of the received signal (Received Signal Strength or “RSS”) to more uniquely identify each location (usually arranged in a grid comprising a plurality of tiles) using RF fingerprint locating methodologies (hereinafter referred to as “fingerprinting”). Naturally, the accuracy of such approach depends on the number of positions that have been entered into the database.

If the mobile device 102 is implemented as a UE device operating in the RAN network, the geolocation application 130 may be configured to passively monitor inter-device communication. In this embodiment, wireless UE devices may use the communications facilities of the radio access network and the Internet to facilitate inter-device communication. This communications mode is sometimes called “over-the-top” (OTT) as it is at the applications layer of the communications hierarchy. Such over-the-top signaling may utilize, for example, the common Internet Protocols TCP/IP or forms of the Short Message Service (SMS). In the alternative embodiment, the geolocation application 130 may be configured to use a network proxy to monitor network traffic information. Yet another alternative embodiment contemplates that the mobile device 102 may obtain the fingerprinting information from an OTT position provider, which may be included in the RAN. It is noted that in order to obtain positioning information using WiFi fingerprinting services the geolocation application 130 may need to bind Mobile Service IP (MSIP) addresses to the IMSIs (International Mobile Subscriber Identifiers). The advantage of obtaining the geolocation information using WiFi fingerprinting services is that such services typically provide substantially accurate information in dense populated areas. However, some of the communication methods described above in relation with the WiFi fingerprinting services may involve unencrypted communication.

If the mobile device 102 includes a satellite signal receiver (e.g., GPS receiver 226 shown in FIG. 2), at step 302, the geolocation application 130 may also obtain geolocation information using the satellite position information source 104. Global navigation satellite systems (GNSS) such as the GPS are widely used to obtain accurate location information based on the observation of satellite signals. This location information can be used directly by the geolocation application 130. Satellite positioning systems can be effective for locating a device's position outdoors, but can be problematic inside buildings or in other places where direct view/line-of-sight of the sky is blocked or obstructed, or reception is poor. Accuracy of the geolocation information provided by the satellite position information source 104 may depend on the number of visible satellites. Therefore, it can be difficult for geolocation application 130 to obtain accurate geolocation positioning data from the satellite information source 104 alone when such complications occur. It is noted that acquiring geolocation information using the satellite position information source 104 may be energy inefficient process within the mobile device 102. In addition to aforementioned WiFi 112 and satellite 104 position information sources, the geolocation application 130 may utilize other 3GPP network compliant location methodologies known in the art.

As previously indicated, the mobile device 102 may also use one or more network based geolocation technologies. One well-known method for locating a mobile device is triangulation. Providers of wireless communication services have installed mobile device location capabilities into their networks. In operation, theses network overlay location systems take measurements on RF transmissions from mobile devices at base station locations surrounding the mobile device and estimate the location of the mobile device with respect to the base stations. Because the geographic location of the base stations is known, the determination of the location of the mobile device with respect to the base station permits the geolocation of the mobile device to be determined. In a triangulation method signal power level or signal timing measurements between the mobile device and three or more base stations are used to triangulate. The signal power level or signal timing measurements are used to estimate the distance between each base station and the mobile device. The distances are plotted to determine a point of intersection. The point of intersection is the approximate transmitter location. For calculations using only signal power measurements, this method works only when the signal strength is relatively strong and not greatly affected by RF fading, such as multipath interference common in urban environments.

Another network-based geolocation technique involves estimating the location of a mobile device using, at least in part, one or more pre-existing Network Measurement Reports (“NMRs”) which may include calibration data and control parameters for a number of locations within a geographic region. The calibration data for these locations is gathered and analyzed so that particular points (e.g., “grid points”) within the geographic region can be determined and associated with a particular set or sets of calibration data from, for example, one or more NMRs. Then, the received signal level measurements and control information reported by the mobile device to be geolocated may be compared with the data associated with various grid points to estimate the location of the mobile device.

The geolocation of a wireless device can also be determined using a cell ID based positioning determination. For example, a cell site in a digital cellular telephone network will typically transmit information that can be used to identify the cell site and a service provider associated with signals transmitted by the cell site. Such information can uniquely identify a signal, particularly when combined with information derived from the signal, including signal frequency, modulation, encoding scheme and, where available, directional information.

Referring back to FIG. 3, at step 302, the geolocation application 130 may collect geolocation information from the plurality of position information sources using a plurality of geolocation technique described above. According to an embodiment of the present invention, at least some of geolocation data may be stored in the database 124 of the storage unit 122. For example, the database 124 may store WiFi fingerprinting information, GPS coordinates, NMRs along with other information described above. In an embodiment of the present invention, the received geolocation information may be associated with a plurality of observed mobile UE communication events, which may also be stored in the database 124.

At step 304, the geolocation application 130 may associate a confidence indicator with each position estimate provided by the plurality of position information sources 104-106 and 112-116. The confidence indicator indicating the level of confidence in a corresponding position estimate value may be generated using a number of different methods. In one embodiment, a statistical analysis of the number of measurement reports used to derive the geolocation information can be used as a basis for calculating the confidence indicator. As number of utilized measurement reports increases the likelihood of more accurate information may increase as well. Similarly, as number of measurement reports utilized for calculation of geolocation information decreases, the likelihood of such geolocation information to be accurate may decrease as well. In an embodiment of the present invention, the geolocation application 130 may determine the confidence indicator based on the number of observed communication events.

The confidence indicator values may use any weighting number system. In particular, the confidence indicators may be normalized so that confidence-based terms can be combined with traditional term-frequency-based terms in record ranking formulas known in the art. The examples contained herein are expressed as percentile, but any expression that allows relative comparisons may be used. As an example, at step 304, the geolocation application 130 may assign a confidence indicator of “85%” to the position estimate value received from the WiFi fingerprinting source 112, “20%” to the position estimate provided by the satellite position information source 104, and “30%” to the position estimate derived using, at least in part, a plurality of measurement reports.

It is noted that the geolocation application 130 may use any method of associating data known in the art. The only requirement is that the confidence indicators are linked somehow with the position estimates to which they correspond. For example, this may be done by appending the confidence indicator values to the existing geolocation data, creating a new data structure that comprises the received position estimates data and the confidence indicators, or a combination thereof. The geolocation application 130 may store the assigned confidence indicators in the database 124.

According to an embodiment of the present invention, at step 306, the geolocation application 130 may combine geolocation information received from the plurality of position information sources 104-106 and 112-116 based on the determined confidence indicator values. In an embodiment of the present invention, the geolocation application 130 may use a linear quadratic estimation (LQE) technique to identify a most likely position value based on the position estimates (received at step 302) and the corresponding confidence indicator values (assigned at step 304). It should be recognized that the geolocation application 130 may use the LQE technique to determine the combined position estimate, but any other statistical algorithm which combines multiple imprecise estimates of a value and yields a more precise estimate may be used. As an example, if the geolocation application 130 received position estimate values from a satellite source 104 and WiFi source 112 and if, at step 304, the geolocation application 130 has determined the confidence indicator values to be 67% and 85%, respectively, then at step 306 the geolocation application 130 may calculate a more precise geolocation position estimate value having a confidence indicator equal to, for example, 95%.

Next, at step 308, the geolocation application 130 may provide a geolocation accuracy indicator value to a user based on the combined confidence indicator calculated at step 306. In an embodiment of the present invention, the geolocation accuracy indicator may identify a predefined degree of accuracy. In one embodiment, the predefined degrees of accuracy may include, but not limited to, “excellent”, “moderate” and “poor”. For example, in response to determining that the confidence indicator value for the most likely position (combined position value) is equal to 95%, the geolocation application 130, at step 308, may generate an accuracy indicator corresponding to the “excellent” category. The geolocation application 130 may store the determined accuracy indicator value in the database 124. The geolocation accuracy indicator may comprise a visual indicator. In an embodiment of the present invention, the geolocation application 130 may use a color coded scheme to represent various degrees of accuracy, such as, for example, red for “poor”, yellow for “moderate” and green for “excellent”. At least in some embodiments of the present invention, the geolocation application 130 may present the calculated geolocation information, such as the most likely position value, along with the corresponding geolocation accuracy indicator and/or confidence indicator values, to the user 108 via the GUI.

Advantageously, the various embodiments described herein provide an energy-efficient method of combining the collected geolocation information from a plurality of sources in order to provide more precise geolocation information. The geolocation can be a geographical (also “geographic” herein) location of a mobile device or a mobile communication event identified by any method for determining or approximating the geolocation described above.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks

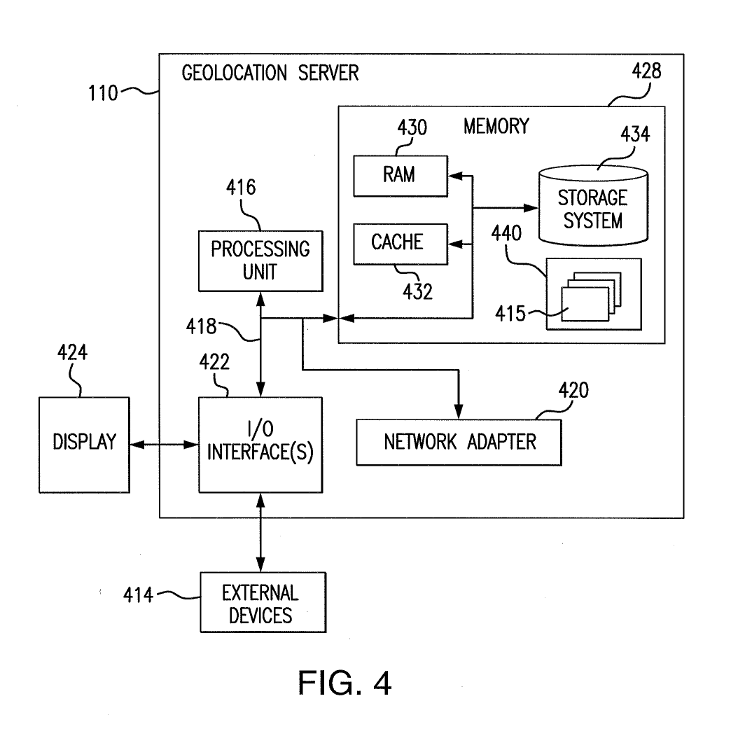

FIG. 4 illustrates internal and external components of the geolocation server 110 in accordance with an illustrative embodiment. The geolocation server 110 is only one example of a suitable server computer and is not intended to suggest any limitation as to the scope of use or functionality of embodiments of the invention described herein. Regardless, the geolocation server 110 is capable of being implemented and/or performing any of the functionality set forth hereinabove.

The geolocation server 110 is operational with numerous other general purpose or special purpose computing system environments or configurations. Examples of well-known computing systems, environments, and/or configurations that may be suitable for use with the geolocation server 110 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

The geolocation server 110 may be described in the general context of computer system-executable instructions, such as program modules, being executed by a computer system. Generally, program modules may include routines, programs, objects, components, logic, data structures, and so on that perform particular tasks or implement particular abstract data types. The geolocation server 110 may be practiced in distributed data processing environments where tasks are performed by remote processing devices that are linked through a communications network. In a distributed data processing environment, program modules may be located in both local and remote computer system storage media including memory storage devices.

The geolocation server 110 is shown in FIG. 4 in the form of a general-purpose computing device. The components of the geolocation server 110 may include, but are not limited to, one or more processors or processing units 416, a system memory 428, and a bus 418 that couples various system components including the system memory 428 to the processor 416.

The bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The geolocation server 110 typically includes a variety of computer system readable media. Such media may be any available media that is accessible by the geolocation server 110, and it includes both volatile and non-volatile media, removable and non-removable media.

The system memory 428 can include computer system readable media in the form of volatile memory, such as random access memory (RAM) 430 and/or cache memory 432. The geolocation server 110 may further include other removable/non-removable, volatile/non-volatile computer system storage media. By way of example only, a storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 418 by one or more data media interfaces. As will be further depicted and described below, the memory 428 may include at least one program product having a set (e.g., at least one) of program modules that are configured to carry out the functions of embodiments of the invention.

A program/utility 440, having a set (at least one) of program modules 415, such as the geolocation application 130, may be stored in the memory 428 by way of example, and not limitation, as well as an operating system, one or more application programs, other program modules, and program data. Each of the operating system, one or more application programs, other program modules, and program data or some combination thereof, may include an implementation of a networking environment. Program modules 415 generally carry out the functions and/or methodologies of embodiments of the invention as described herein.

The geolocation server 110 may also communicate with one or more external devices 414 such as a keyboard, a pointing device, a display 424, etc.; one or more devices that enable a user to interact with the geolocation server 110; and/or any devices (e.g., network card, modem, etc.) that enable the geolocation server 110 to communicate with one or more other computing devices. Such communication can occur via Input/Output (I/O) interfaces 422. Still yet, the geolocation server 110 can communicate with one or more networks such as a local area network (LAN), a general wide area network (WAN), and/or a public network (e.g., the Internet) via a network adapter 420. As depicted, the network adapter 420 communicates with the other components of the geolocation server 110 via the bus 418. It should be understood that although not shown, other hardware and/or software components could be used in conjunction with the geolocation server 110. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing accurate geolocation information, the method comprising the steps of:
receiving geolocation information from a plurality of position information sources;
associating a confidence indicator with each of the plurality of position information sources;
combining the geolocation information received from two or more of the plurality of position information sources based on the confidence indicator associated with each of the plurality of position information sources; and
providing a geolocation accuracy indicator.

2. The method of claim 1, wherein the received geolocation information comprises a plurality of position estimate values.

3. The method of claim 1, wherein the received geolocation information is associated with a plurality of observed mobile user equipment communication events.

4. The method of claim 3, wherein the confidence indicator is determined based on the plurality of observed mobile user equipment communication events.

5. The method of claim 1, wherein at least one of the plurality of position information sources comprises a WiFi fingerprinting source.

6. The method of claim 1, wherein at least one of the plurality of position information sources comprises a satellite navigation system.

7. The method of claim 1, wherein the received geolocation information is determined based on one or more device measurement reports.

8. The method of claim 7, wherein the one or more measurement reports comprise timing advance information.

9. The method of claim 7, wherein the confidence indicator is determined based on a number of measurement reports utilized to determine the received geolocation information.

10. The method of claim 1, wherein combining the geolocation information comprises identifying a most likely position based on the confidence indicator.

11. The method of claim 1, wherein the geolocation accuracy indicator identifies a predefined degree of accuracy.

12. The method of claim 7, wherein the geolocation accuracy indicator is a visual indicator presented to a user.

13. The method of claim 7, wherein the geolocation accuracy indicator comprises a color coded visual indicator.

14. A computer program product for providing accurate geolocation information, the computer program product comprising:
one or more computer-readable storage devices and a plurality of program instructions stored on at least one of the one or more computer-readable storage devices, the plurality of program instructions comprising:
program instructions to receive geolocation information from a plurality of position information sources;
program instructions to associate a confidence indicator with each of the plurality of position information sources;
program instructions to combine the geolocation information received from two or more of the plurality of position information sources based on the confidence indicator associated with each of the plurality of position information sources; and
program instructions to provide a geolocation accuracy indicator.

15. The computer program product of claim 14, wherein the program instructions to receive geolocation information comprise program instructions to receive a plurality of position estimate values.

16. The computer program product of claim 14, wherein the received geolocation information is associated with a plurality of observed mobile user equipment communication events.

17. The computer program product of claim 16, wherein the confidence indicator is determined based on the plurality of observed mobile user equipment communication events.

18. The computer program product of claim 14, wherein at least one of the plurality of position information sources comprises a WiFi fingerprinting source.

19. The computer program product of claim 14, wherein at least one of the plurality of position information sources comprises a satellite navigation system.

20. The computer program product of claim 14, wherein the geolocation accuracy indicator comprises a color coded visual indicator.
